(19) United States
(12) Patent Application Publication
(10) Pub. No.: US 2026/0072895 A1
(43) Pub. Date: Mar. 12, 2026

(54) METHOD, APPARATUS, DEVICE AND MEDIUM FOR MANAGING DATA TABLES

(71) Applicant: Beijing Zitiao Network Technology Co., Ltd., Beijing (CN)

(72) Inventor: Meng Han, Beijing (CN)

(21) Appl. No.: 19/320,115

(22) Filed: Sep. 5, 2025

(30) Foreign Application Priority Data
Sep. 6, 2024 (WO) PCT/CN2024/117570

(51) Int. Cl. G06F 16/22; G06F 40/171

(52) U.S. Cl. CPC G06F 16/2282; G06F 40/171

(57) ABSTRACT

A method, an apparatus, a device, and a media for managing a data table are provided. In the method, a folding control for folding a data dimension group in the data table is presented, the data dimension group including a base data dimension and at least one other data dimension than the base data dimension. In response to receiving an interaction request for the folding control, the base data dimension in the data dimension group is presented, and the at least one other data dimension is set to be invisible. With the example implementation of the disclosure, in a folded state, the base data dimension is displayed as a representation of the data dimension group, thereby enabling a user to know that the data dimension group being displayed in folded state is included in the data table.

### CROSS-REFERENCE

This application claims priority to PCT Application No. PCT/CN2024/117570 filed on Sep. 6, 2024, and entitled “METHOD, APPARATUS, DEVICE AND MEDIUM FOR MANAGING DATA TABLE”, the entirety of which is incorporated herein by reference.

### FIELD

Example implementations of the disclosure generally relate to data storage, and more particularly to a method, an apparatus, a device, and a computer-readable storage media for managing a data table.

### BACKGROUND

In a data storage scene, a data table is a common data storage manner. As an amount of data increases, a data table may include a large number of data dimensions (e.g., data columns or data rows). This results in that when the data table is presented in a tiled manner, all data dimensions cannot be presented simultaneously, and at this time, a user needs to search for a concerned data dimension by using a control such as a search control or a scroll bar. At this time, it is desirable to manage various data dimensions in the data table in a more convenient and efficient manner and improve data access efficiency.

### SUMMARY

In a first aspect of the disclosure, a method for managing a data table is provided. In the method, a folding control for folding a data dimension group in the data table is presented, the data dimension group including a base data dimension and at least one other data dimension than the base data dimension. In response to receiving an interaction request for the folding control, the base data dimension in the data dimension group is presented, and the at least one other data dimension is set to be invisible.

In a second aspect of the disclosure, an apparatus for managing a data table is provided. The apparatus includes: a presenting module configured to, present a folding control for folding a data dimension group in the data table, the data dimension group comprising a base data dimension and at least one other data dimension than the base data dimension; and a folding module configured to, in response to receiving an interaction request for the folding control, present the base data dimension in the data dimension group, and set the at least one other data dimension to be invisible.

In a third aspect of the disclosure, an electronic device is provided. The electronic device includes: at least one processing unit; and at least one memory coupled to the at least one processing unit and storing instructions for execution by the at least one processing unit, the instructions, when executed by the at least one processing unit, causing the electronic device to perform the method according to the first aspect of the disclosure.

In a fourth aspect of the disclosure, a computer-readable storage medium is provided. The computer-readable storage medium storing a computer program thereon which, when executed by a processor, causes the processor to implement the method according to the first aspect of the disclosure.

In a fifth aspect of the disclosure, a computer program product is provided. The computer program product includes a computer program, wherein the computer program, when executed by a processor, implements the method according to the first aspect of the disclosure.

It should be understood that the content described in the summary section is not intended to limit key features or important features of implementations of the disclosure, nor is it intended to limit the scope of the disclosure. Other features of the disclosure will become readily understood from the following description.

### BRIEF DESCRIPTION OF DRAWINGS

In the following, the above and other features, advantages, and aspects of the various implementations of the disclosure will become more apparent from the following detailed description taken in conjunction with the accompanying drawings. In the drawings, the same or similar reference numbers refer to the same or similar elements, wherein:

FIG. 1 illustrates a block diagram of an application environment according to an example implementation of the disclosure;

FIG. 2 illustrates a block diagram for managing a data table according to some implementations of the disclosure;

FIG. 3 illustrates a block diagram for setting a group according to some implementations of the disclosure;

FIG. 4 illustrates a block diagram for unfolding a data column group according to some implementations of the disclosure;

FIG. 5 illustrates a block diagram for setting a color of a group according to some implementations of the disclosure;

FIG. 6 illustrates a block diagram for managing a data column group according to some implementations of the disclosure;

FIG. 7 illustrates a block diagram for adjusting a base column according to some implementations of the disclosure;

FIG. 8 illustrates a block diagram for folding a group according to some implementations of the disclosure;

FIG. 9 illustrates a flowchart of a method for managing a data table according to some implementations of the disclosure;

FIG. 10 illustrates a block diagram of an apparatus for managing a data table according to some implementations of the disclosure; and

FIG. 11 illustrates a block diagram of a device capable of implementing various implementations of the disclosure.

### DETAILED DESCRIPTION

Implementations of the disclosure will be described in more detail below with reference to the accompanying drawings. While certain implementations of the disclosure are shown in the accompanying drawings, it should be understood that the disclosure may be implemented in various forms and should not be construed as limited to the implementations set forth herein, but rather, these implementations are provided for a more thorough and complete understanding of the disclosure. It should be understood that the drawings and implementations of the disclosure are for illustrative purposes only and are not intended to limit the scope of the disclosure.

In the description of implementations of the disclosure, the terms “comprising”, “including” and the like should be understood to be open-ended, i.e., “including but not limited to”. The term “based on” should be understood as “based at least in part on”. The terms “one implementation” or “the implementation” should be understood as “at least one implementation”. The term “some implementations” should be understood as “at least some implementations”. Other explicit and implicit definitions may also be included below. As used herein, the term “model” may represent an association between various data. For example, the above association may be obtained based on various technical solutions currently known and/or to be developed in the future.

It may be understood that the data involved in the technical solution (including but not limited to the data itself, the acquisition or use of the data) should follow the requirements of the corresponding laws and regulations and related rules.

It may be understood that, before the technical solutions disclosed in the embodiments of the disclosure are used, the types, the usage scope, the usage scenario and the like of personal information related to the disclosure should be notified to the user in an appropriate manner according to the relevant laws and regulations, and the authorization of the user is obtained.

For example, in response to receiving an active request from a user, prompt information is sent to the user to explicitly prompt the user that the requested operation to be performed would require acquisition and use of personal information of the user. Therefore, the user can autonomously select whether to provide personal information to software or hardware such as an electronic device, an application, a server, or a storage medium that performs the operations of the technical solution of the disclosure, according to the prompt information.

As an optional but non-limiting implementation, in response to receiving an active request from the user, a manner of sending prompt information to the user may be, for example, a pop-up window, and prompt information may be presented in a text manner in the pop-up window. In addition, the pop-up window may further carry a selection control for the user to select “agree” or “disagree”to provide personal information to the electronic device.

It may be understood that the foregoing notification and obtaining a user authorization process is merely illustrative and does not constitute a limitation on implementations of the disclosure, and other manners of meeting related laws and regulations may also be applied to implementations of the disclosure.

The term “in response to” as used herein means a state in which a respective event occurs, or condition is satisfied. It will be appreciated that the timing of execution of a subsequent action performed in response to the event or condition is not necessarily strongly correlated with the time at which the event occurs, or the condition holds. For example, in some cases, subsequent actions may be performed immediately when the event occurs or the condition holds; while in other cases, subsequent actions may be performed after a period of time elapses after the event occurs or the condition holds.

### Example Environment

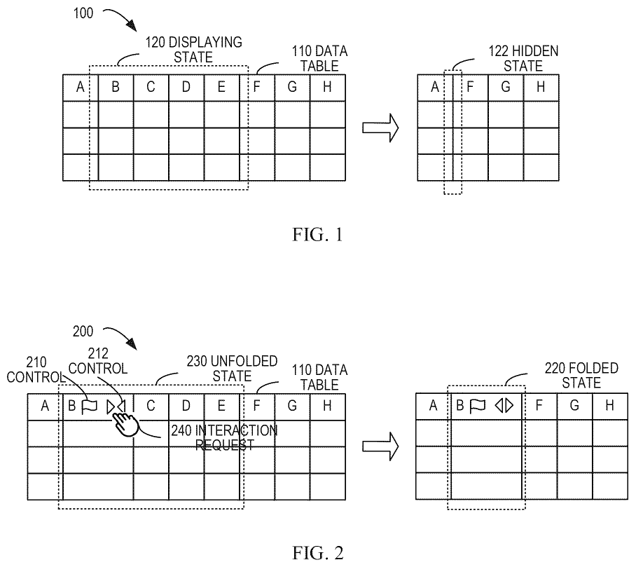

As an amount of data increases, a data table may include a large number of data dimensions. This results in that when the data table is presented in a tiled manner, all data dimensions cannot be presented simultaneously, and at this time, a user needs to find a data dimension desired to be viewed by using a control such as a search control or a scroll bar. Here, the data dimension may include data columns or data rows. For ease of description, in the following, specific details of managing the data table are described by using only data columns as example of data dimensions. An application environment according to some implementations of the disclosure is described with reference to FIG. 1. FIG. 1 illustrates a block diagram 100 of an application environment according to some implementations of the disclosure. As shown in FIG. 1, the data table 110 includes a plurality of data columns, represented as data columns A, B, C, D, E, F, G, and H respectively. Existing data table management tools provide the functionality of “displaying/hiding” the data columns.

A user may select one or more data columns, e.g., data columns B, C, D, E, and set the above data columns to displayed state 120. At this time, the data columns B, C, D, E will be normally displayed. The user may hide one or more data columns, for example, selected data columns B, C, D, E may be set to the hidden state 122. At this time, data columns B, C, D, E will be hidden, and data column A and data column F are directly adjacent. Although the “displaying/hiding” function can hide a portion of the data columns, thereby reducing a width of the data table 110, the user cannot know which data columns are hidden, thereby possibly missing critical data in the data table. At this time, it is desirable to manage various data columns in the data table in a more convenient and efficient manner and improve data access efficiency.

Summary for Managing Data Tables In order to at least partially solve the deficiencies in the prior art, according to an example implementation of the disclosure, a method for managing a data table is provided. Referring to FIG. 2, a summary is described according to an example implementation of the disclosure. FIG. 2 illustrates a block diagram 200 for managing a data table according to some implementations of the disclosure. As shown in FIG. 2, a folding control, e.g., control 212 for folding a data column group in data table 110 may be presented. Here, the data column group may include a base data column and at least one other data column than the base data column. Specifically, the data column group includes a plurality of data columns B, C, D, E, where the data column B is a base data column, and the other data columns may include data columns C, D, and E.

In an unfolded mode 230, a plurality of data columns B, C, D, E in the data column group is presented. A control 212 may be provided to display a plurality of data columns in the data column group in a folded state 220. In response to receiving the interaction request 240 for the folding control, only the base data column in the data column group is presented, and at least one other data column is hidden (i.e., the at least one other data column is set to be invisible). As shown on the right side of FIG. 2, only the base data column B is displayed in the folded state 220, and the other data columns C, D, E are hidden (i.e., set to be invisible). Further, the control 210 may be presented with a flag icon to indicate a location of the base data column B.

With example implementations of the disclosure, the data column group may include the base data column and other at least one common data column. A data column capable of representing a plurality of data columns can be selected as the base data column, and only base data column are displayed in the folded state. In this manner, in the folded state, the base data column will be displayed as a representation of the data column group, thereby enabling the user to know that the data column group being displayed in folded state is included in the data table.

### Detailed Process for Managing Data Tables

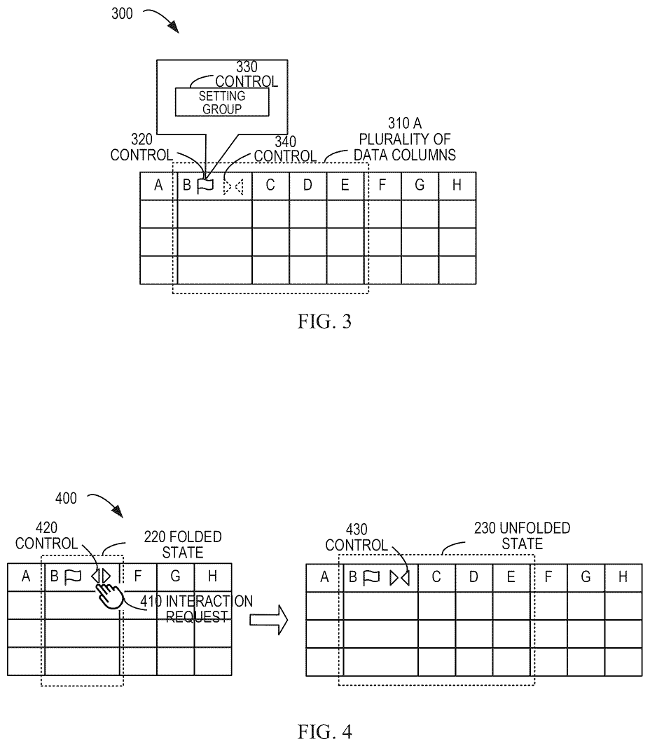

Having described a summary according to some implementations of the disclosure, more details regarding managing a data table will be described below. According to some implementations of the disclosure, a user may select a plurality of data columns in a data table and create a data column group. Referring to FIG. 3 for more details, FIG. 3 illustrates a block diagram 300 for setting a group in accordance with some implementations of the disclosure. As shown in FIG. 3, the user may select (e.g., by block selection, etc.) a plurality of data columns 310. In response to receiving a selection request for the plurality of data columns 310 in the data table, a grouping control, such as control 320, for setting the data column group may be presented. The user may click the group control in order to set the data group. In response to receiving an interaction request for the grouping control, a plurality of data columns 310 may be added to the data column group.

It should be understood that the plurality of data columns selected here may be ordered consecutively or may not be consecutively ordered. At this time, the non-base data columns added to the plurality of data columns of the data column group may be hidden. For example, a user may select data columns B, D, and F in FIG. 3, assuming that data column B is the base data column, and in a folded state, data columns D and F will be hidden. In this way, flexible selection of data columns desired to be added to the group may be supported.

According to some implementations of the disclosure, where a plurality of data columns 310 are selected, the user may click a control 320 to create a new data column group directly based on the plurality of data columns 310. Alternatively, and/or additionally, in response to detecting that the control 320 is clicked, a further setting page may be popped. For example, the page may include a control 330, and the user may click the control 330 to create a data column group. Alternatively, and/or additionally, one or more data column groups already present may be presented, and the user may select one data column group from one or more data column groups already present and add the plurality of data columns 310 to the selected data column group. In this manner, a variety of flexible ways to set the group may be provided to manage the data table in a simpler and efficient manner.

According to some implementations of the disclosure, a data column at a predetermined position in the plurality of data columns 310 may be used as a default base data column. For example, a first data column, a data column at an intermediate position, or a last data column may be used as the default data column. Alternatively, and/or additionally, a data column corresponding to the interaction request (e.g., mouse cursor or user finger position) may be used as the default data column. In this way, the flexibility of setting the base data column can be conveniently improved, thereby managing the data table in a simpler and effective manner.

According to some implementations of the disclosure, after the data column group has been created, a control 340 for folding the group may be presented. At this time, in response to detecting an interaction request for the control 340, only a base data column B may be displayed, and other data columns C, D, E in the data column group may be hidden.

According to some implementations of the disclosure, in the folded state, an unfolding control for unfolding the data column group may be presented. Further, in response to receiving an interaction request for the unfolding control, at least one other data column of the data column group may be presented (i.e., set to visible). More details are described with reference to FIG. 4. FIG. 4 illustrates a block diagram 400 for unfolding the data column group according to some implementations of the disclosure. As shown on the left side of FIG. 4, in the folded state 220, a control 420 may be presented. In response to detecting an interaction request 410 for the control 420, the folded data column group may be unfolded. As shown on the right side of FIG. 4, the data column group is in the unfolded state 230 and all data columns B, C, D, E are displayed. Further, the control 430 for folding the data column group may be presented. With some implementations of the disclosure, the displaying manner of the data column group can be switched in a more convenient and effective manner.

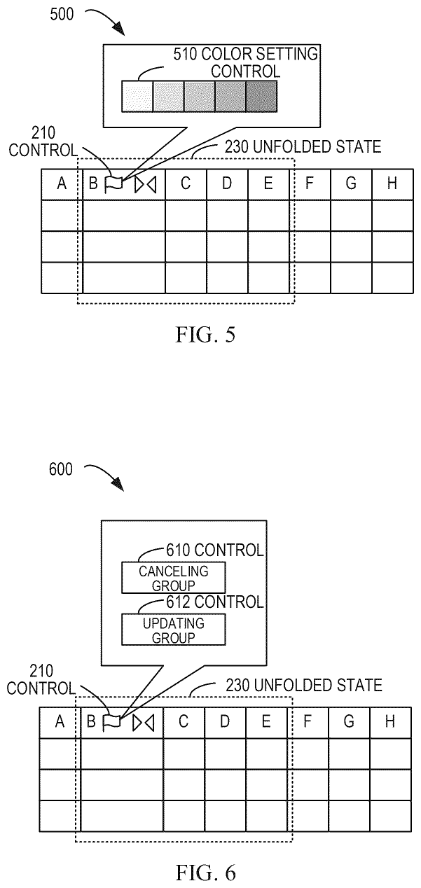

According to some implementations of the disclosure, a setting control for setting the data column group may be presented. In response to receiving an interaction request for the setting control, a setting page is presented, and the setting page includes a color setting control for setting a color of the data column group. More details are described with reference to FIG. 5. FIG. 5 illustrates a block diagram 500 for setting a color of the group according to some implementations of the disclosure. As shown in FIG. 5, the control, such as a control 210, may be presented in a flag icon. The control 210 may be clicked to present a settings page that includes more controls. For example, the setting page may include a color setting control 510, and in response to receiving an interaction request for the color setting control 510, a color of the data column group may be set.

With some implementations of the disclosure, data column groups are allowed to be distinguished in different colors. For example, the color may be utilized to set bottom colors, colors of the heads, bottom colors of the wireframes of data columns in the data column group and/or a text color of a data item in the data column and the like. In this way, the user may be supported to highlight the data column of interest, thereby improving the visualization effect of the data table.

According to some implementations of the disclosure, a setting control may be presented at a position corresponding to the base data column. As shown in FIG. 5, the control 210 may be displayed at a head position of the base data column B. With some implementations of the disclosure, the base data column in a plurality of data columns can be conveniently distinguished, thereby facilitating further operation of the user. Alternatively, and/or additionally, other indicia may be utilized to indicate the base data column, e.g., the base data column may be indicated using bold, large, highlighting, underlining, etc. A setting control may be displayed across the headers of a plurality of data columns in the data column group. For example, a semi-transparent floating layer may be provided at a head position or other position of the plurality of data columns, and the setting control may be displayed in the floating layer, and so on.

According to some implementations of the disclosure, the setting page further includes a canceling control for ungrouping the data column group. In response to receiving an interaction request for the canceling control, the data column group may be ungrouped (i.e., the data column group may be canceled). More details are described with reference to FIG. 6. FIG. 6 illustrates a block diagram 600 for managing a data column group according to some implementations of the disclosure. As shown in FIG. 6, in response to receiving an interaction request for the control 210, a setting page including a control 610 may be presented. The control 610 is configured to cancel (i.e., ungroup) the current data column group, specifically, in response to determining that the user clicks the control 610, a plurality of data columns B, C, D, and E may be restored to a regular data column. At this time, the group will be cancelled, and the plurality of data columns B, C, D, and E are no longer located in the group. According to some implementations of the disclosure, one data column can be specified to be only added to a single data column group. In this way, the situation that the displayed state conflicts can be avoided.

According to some implementations of the disclosure, the setting page may further include: an updating control for updating the data column group, such as a control 612. In response to receiving an interaction request for the updating control, a plurality of data columns in the data column group are updated based on the interaction request. In response to receiving an interaction request for the control 612, an identifier of a plurality of data columns included in a current group may be presented. The user may select an identifier of a data column expected to be deleted from the current group. Alternatively, and/or additionally, the identifier of the plurality of data columns not included in the current group may be presented in a different format such that the user selects one or more data columns that are expected to be added to the current group. With some implementations of the disclosure, the data table may be managed in a more flexible and efficient manner.

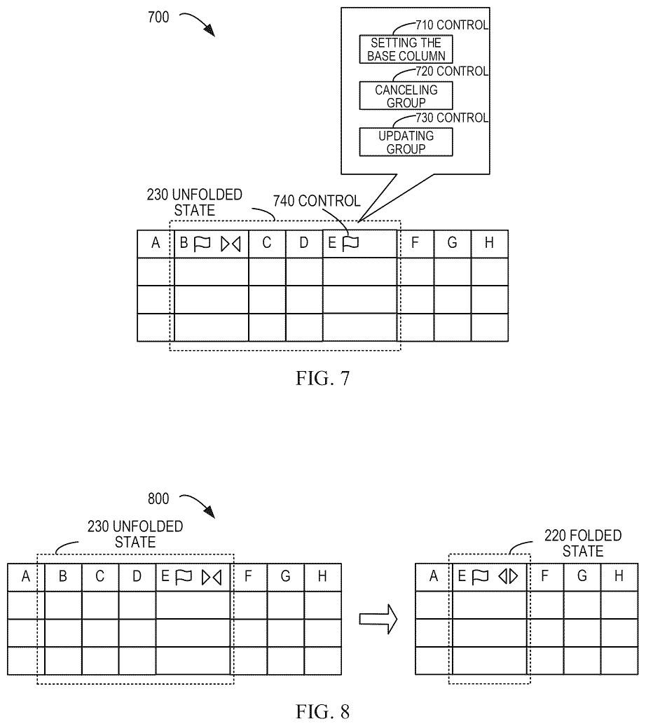

According to some implementations of the disclosure, a user may perform other interaction operations with data columns in the data column group. In response to determining that an interaction request with the data column group satisfies a predetermined condition, a setting control for setting the data column group may be presented. For example, the user may click other data columns than the base data column, may hover a mouse cursor over a certain data column, and so on. At this time, a setting control may be provided, referring to FIG. 7 to describe more details. FIG. 7 illustrates a block diagram 700 for adjusting a base column according to some implementations of the disclosure. As shown in FIG. 7, in response to determining that the user clicks data column E, or the staying time at data column E is above a certain time threshold (e.g., 2 seconds or other numerical value), a settings control, such as a control 740, may be presented.

Further, in response to receiving user interaction with a space 740, a settings page may be provided. The setting page may include a base column setting control for setting the base data column, as shown in a control 710 in FIG. 7. In response to receiving an interaction request for the base column setting control, setting a target data column in the at least one other data column as the base data column of the data column group. In this time, the current data column E may be set as the base data column. In this way, the base data column can be quickly modified, thereby improving the managing efficiency of the data table.

After the data column E is set as the base data column, a block diagram as shown in FIG. 8 may be presented. FIG. 8 illustrates a block diagram 800 for folding a group according to some implementations of the disclosure. As shown on the left side of FIG. 8, the base data column of the data column group has been updated from data column B to data column E. The right side of FIG. 8 illustrates the data column group in folded state 220, at which point only the data column E is displayed, and the other data columns B, C, D are hidden.

Returning to FIG. 7, the setting page may further include a control 720 for canceling (i.e., ungrouping) the current data column group, and a control 730 for updating the current data column group. Here, the functions of the controls 720 and 730 are similar to those of the controls 610 and 612 in FIG. 6, and details are not described herein again.

It should be understood that while one data column group is described above as including only one base data column, one data column group may alternatively and/or additionally include a plurality of base data columns. For example, the setting page in FIG. 7 may further include an adding control for adding the base column. In response to receiving a user interaction for the adding control, the data column E may also be taken as another base data column, where the data column group may include two base data columns: data columns B and E. At this time, flag icons may be displayed at header positions of data columns B and E to indicate the base data columns. Upon folding the data column group, data columns B and E will be displayed, and data columns C and D will be hidden.

With some implementations of the disclosure, a user is allowed to set a plurality of data columns of desired attention as base data columns, thereby improving flexibility of managing the data table. Specifically, it is assumed that the data table is a performance score of the student, and one data column group may include a plurality of mathematical achievements, for example, a total evaluation score, a final examination score, a middle examination score, and an operation score. At this time, the user “user01” (e.g., a math teacher) may set the total evaluation score and the final examination score as the base data column. In this way, other data columns with lower interest degree may be hidden.

According to some implementations of the disclosure, the data column group may be associated with a user viewing a data table. For example, another data column group in the data table may include a plurality of English achievements, such as, for example, a total evaluation score, a final examination score, a middle examination score, and an operation score. At this time, the user “user02” (for example, the English teacher) may set the total evaluation score and the final examination score of the English as the base data column. In this way, other data columns with lower interest degree may be hidden, for example, the middle examination score, the operation score of English, and all mathematical achievements.

According to some implementations of the disclosure, a state information of the data column group may be stored in configuration data of the user associated with the data table. The state information may include at least one of the following: an identifier and a color of the data column group, a presentation state of the data column group, an identifier of a plurality of data columns, and an identifier of the base data column. Continuing with the above example, state information about the data column group “group01” may be written into configuration data of the user “user01”. Group01 may include state information for a plurality of data columns associated with a mathematical achievement. For another example, state information about the data column group “group02” may be written into configuration data of the user “user02”. Group02 may include state information for a plurality of data columns associated with an English achievement. Alternatively, and/or additionally, the relevant data presenting only certain data column group can be set in the configuration data. In this way, each user is allowed to define the group and the corresponding state information according to his/her own requirement, thereby improving the efficiency of managing the data table.

According to some implementations of the disclosure, before the user accesses a certain data table, related configuration information may be read first, and then each data column in the data table is presented according to the configuration information. Specifically, in response to receiving an interaction request from the user for accessing the data table, the state information of the data column group is read from the configuration data of the user. Further, the data table may be presented based on the state information. Continuing the example above, the user “user01” may be presented with a data column about the mathematical achievements, and the user “user02” may be presented with a data column about the English achievements. In this way, the data column of interest to each user can be displayed according to the configuration data, thereby improving the efficiency of obtaining the information by the user.

According to some implementations of the disclosure, an attribute of an electronic device accessing the data table may be further obtained, and a detailed presenting manner is determined based on the attribute. For example, assuming that the electronic device is a portable electronic device having a limited display area, a resolution of the display area may be obtained, and a displaying width of each data column may be set based on the resolution. For another example, the configuration data may further include time information that each data column group is unfolded/folded, and one data column group or some data column groups may be folded based on the time information. For example, even if the data column group “group01” is currently being displayed in unfolded manner, if the configuration data indicates that the data column group “group01” is in a folded state for a long period of time in the past, the data column group “group01” may be folded, and so on.

According to some implementations of the disclosure, the data table may be a local data table located in the electronic device. Alternatively, and/or additionally, the data table may be an online data table, at which point a copy of the data table is not included locally at the electronic device, but rather the electronic device is merely a browsing device viewing content located in a remote data table. In this way, by setting and folding the functionality of the group, a large-scale data table with a large number of data columns is allowed to be viewed at regular electronic devices.

According to some implementations of the disclosure, an editing tool for configuring data may be provided to set a state of a data column group in a specified format. For example, an identifier of each data column in a data table may be obtained, a set of data columns may be selected, and a group is created, and a state of the group may be set. Further, the state may be stored in the configuration data to present the data table based on the configuration data when the data table is accessed next time. It should be understood that although the foregoing merely shows a case in which the data table includes one data column group, the data table may include a plurality of data column groups. Each data column group may be processed in a process similar to that described above. In this way, the efficiency of managing the data table can be improved.

With some implementations of the disclosure, a data column capable of representing a plurality of data columns can be selected as the base data column, and only base data column is displayed in the folded state. In this manner, in the folded state, the base data column will be displayed as a representation of the data column group, thereby enabling the user to know that the data column group being displayed in folded state is included in the data table.

It should be understood that although the process of managing the data table is described above in terms of data columns as examples of data dimensions. Alternatively, and/or additionally, the data dimension may include data rows, in particular, the data row group may be set using a method similar to that described above, a base data row may be set for the data row group, and the data row group may be folded or unfolded. With some implementations of the disclosure, flexible and efficient operations are allowed to be performed on data rows in a data table.

### Example Processes

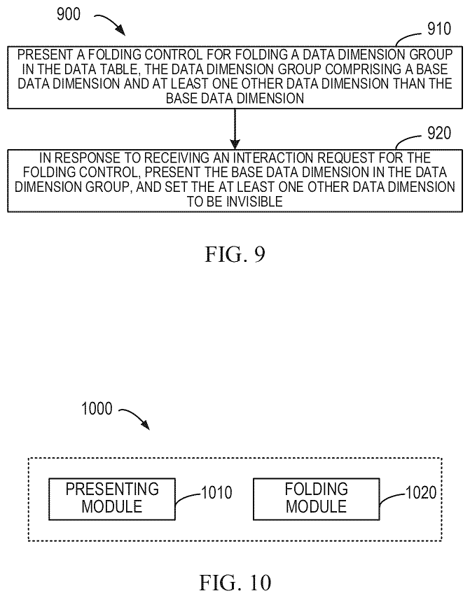

FIG. 9 illustrates a flowchart of a method 900 for managing a data table according to some implementations of the disclosure. At block 910, presenting a folding control for folding a data dimension group in the data table, the data dimension group comprising a base data dimension and at least one other data dimension than the base data dimension. At block 920, in response to receiving an interaction request for the folding control, presenting the base data dimension in the data dimension group, and setting the at least one other data dimension to be invisible.

According to some implementations of the disclosure, the data dimension group is determined based on: in response to receiving a selection request for a plurality of data dimensions in the data table, presenting a grouping control for setting the data dimension group; and in response to receiving an interaction request for the grouping control, adding the plurality of data dimensions to the data dimension group.

According to some implementations of the disclosure, the method further includes: presenting an unfolding control for unfolding the data dimension group; and in response to receiving an interaction request for the unfolding control, setting the at least one other data dimension in the data dimension group to be visible.

According to some implementations of the disclosure, the method further includes: presenting a setting control for setting the data dimension grouping; in response to receiving an interaction request for the setting control, presenting a setting page, the setting page comprising a color setting control for setting a color of the data dimension group; and in response to receiving an interaction request for the color setting control, setting the color of the data dimension group.

According to some implementations of the disclosure, presenting the setting control includes: presenting the setting control at a location corresponding to the base data dimension.

According to some implementations of the disclosure, the setting page further includes: a canceling control for ungrouping the data dimension group, and the method further includes: in response to receiving an interaction request for the canceling control, ungrouping the data dimension group.

According to some implementations of the disclosure, the setting page further includes: an updating control for updating the data dimension group; and the method further includes: in response to receiving an interaction request for the updating control, updating the plurality of data dimensions in the data dimension group based on the interaction request.

According to some implementations of the disclosure, the method further includes: in response to determining that an interaction request with the data dimension group satisfies a predetermined condition, presenting a base column setting control for setting the base data dimension; and in response to receiving an interaction request for the base column setting control, setting a target data dimension in the at least one other data dimension as the base data dimension of the data dimension group.

According to some implementations of the disclosure, the method further includes: storing state information of the data dimension group in configuration data of a user associated with the data table, the state information comprising at least one of the following: an identifier and a color of the data dimension group, a presentation state of the data dimension group, an identifier of the plurality of data dimensions, and an identifier of the base data dimension.

According to some implementations of the disclosure, the method further includes: in response to receiving an interaction request from the user for accessing the data table, reading the state information of the data dimension group from the configuration data of the user; and presenting the data table based on the state information.

According to some implementations of the disclosure, wherein the data dimension includes at least one of a data row and a data column.

### Example Apparatus and Device

FIG. 10 illustrates a block diagram of an apparatus 1000 for managing a data table according to some implementations of the disclosure. The apparatus 1000 includes: a presenting module 1010 configured to, present a folding control for folding a data dimension group in the data table, the data dimension group comprising a base data dimension and at least one other data dimension other than the base data dimension, and a folding module 1020 configured to, in response to receiving an interaction request for the folding control, present the base data dimension in the data dimension group, and set the at least one other data dimension to be invisible.

According to some implementations of the disclosure, the apparatus 1000 further includes: a grouping module configured to: in response to receiving a selection request for a plurality of data dimensions in the data table, present a grouping control for setting the data dimension group; and in response to receiving an interaction request for the grouping control, add the plurality of data dimensions to the data dimension group.

According to some implementations of the disclosure, the apparatus 1000 further includes an unfolding module configured to: present an unfolding control for unfolding the data dimension group; and in response to receiving an interaction request for the unfolding control, set the at least one other data dimension in the data dimension group to be visible.

According to some implementations of the disclosure, the apparatus 1000 further includes a setting module configured to: present a setting control for setting the data dimension group; in response to receiving an interaction request for the setting control, present a setting page, the setting page comprising a color setting control for setting a color of the data dimension group; and in response to receiving an interaction request for the color setting control, set the color of the data dimension group.

According to some implementations of the disclosure, the setting module is further configured to present the setting control at a location corresponding to the base data dimension.

According to some implementations of the disclosure, the setting page further includes: a canceling control for ungrouping the data dimension group, and the setting module is further configured to: in response to receiving an interaction request for the canceling control, ungroup the data dimension group.

According to some implementations of the disclosure, the setting page further includes: an updating control for updating the data dimension group; and the setting module is further configured to: in response to receiving an interaction request for the updating control, update the plurality of data dimensions in the data dimension group based on the interaction request.

According to some implementations of the disclosure, the setting module is further configured to: in response to determining that an interaction request with the data dimension group satisfies a predetermined condition, present a base column setting control for setting the base data dimension; and in response to receiving an interaction request for the base column setting control, set a target data dimension in the at least one other data dimension as the base data dimension of the data dimension group.

According to some implementations of the disclosure, the setting module is further configured to: store state information of the data dimension group in configuration data of a user associated with the data table, the state information comprising at least one of the following: an identifier and a color of the data dimension group, a presentation state of the data dimension group, an identifier of the plurality of data dimensions, and an identifier of the base data dimension.

According to some implementations of the disclosure, the setting module is further configured to: in response to receiving an interaction request from the user for accessing the data table, read the state information of the data dimension group from the configuration data of the user; and present the data table based on the state information.

According to some implementations of the disclosure, wherein the data dimension includes at least one of a data row and a data column.

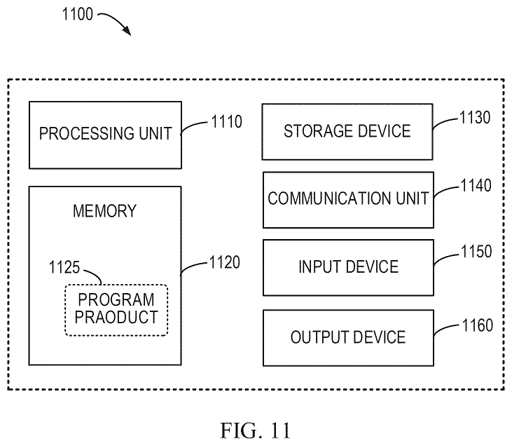

FIG. 11 illustrates a block diagram of a device 1100 capable of implementing various implementations of the disclosure. It should be understood that the computing device 1100 shown in FIG. 11 is merely exemplary and should not constitute any limitation on the functionality and scope of the implementations described herein. The computing device 1100 shown in FIG. 11 may be configured to implement the method described above.

As shown in FIG. 11, the computing device 1100 is in the form of a general-purpose computing device. Components of the computing device 1100 may include, but are not limited to, one or more processors or processing units 1110, a memory 1120, a storage device 1130, one or more communication units 1140, one or more input devices 1150, and one or more output devices 1160. The processing unit 1110 may be an actual or virtual processor and capable of performing various processes according to programs stored in the memory 1120. In multiprocessor systems, multiple processing units execute computer-executable instructions in parallel to improve parallel processing capabilities of computing device 1100.

The computing device 1100 typically includes a plurality of computer storage media. Such media may be any available media accessible by the computing device 1100, including, but not limited to, volatile and non-volatile media, removable and non-removable media. The memory 1120 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 1130 may be a removable or non-removable medium and may include a machine-readable medium, such as a flash drive, magnetic disk, or any other medium, which may be capable of storing information and/or data (e.g., training data for training) and may be accessed within computing device 1100.

The computing device 1100 may further include additional removable/non-removable, volatile/non-volatile storage media. Although not shown in FIG. 11, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 1120 may include a computer program product 1125 having one or more program modules configured to perform various methods or actions of various implementations of the disclosure.

The communications unit 1140 implements communications with other computing devices over a communications medium. Additionally, the functionality of components of the computing device 1100 may be implemented in a single computing cluster or multiple computing machines capable of communicating over a communication connection. Thus, the computing device 1100 may operate in a networked environment using logical connections with one or more other servers, network personal computers (PCs), or another network node.

The input device 1150 may be one or more input devices, such as a mouse, a keyboard, a trackball, or the like. The output device 1160 may be one or more output devices, such as a display, a speaker, a printer, or the like. Computing device 1100 may also communicate with one or more external devices (not shown) through the communication unit 1140 as needed, external devices such as storage devices, display devices, etc., communicate with one or more devices that enable a user to interact with computing device 1100, or communicate with any device (e.g., network card, modem, etc.) that enables computing device 1100 to communicate with one or more other computing devices. Such communication may be performed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, the computer program product being tangibly stored on a non-transitory computer-readable medium and including computer-executable instructions, the computer-executable instructions being executed by a processor to implement the method described above. According to example implementations of the disclosure, there is provided a computer program product having stored thereon a computer program, which when executed by a processor, implements the method described above.

Aspects of the disclosure are described herein with reference to flowcharts and/or block diagrams of methods, apparatuses, devices, and computer program products implemented in accordance with the disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce apparatus to implement the functions/acts specified in the flowchart and/or block(s) in block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block(s) in block diagram.

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in the flowchart and/or block(s) in block diagram.

The flowchart and block diagrams in the figures show architecture, functionality, and operation of possible implementations of systems, methods, and computer program products according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

I/We claim:

1. A method for managing a data table comprising:
presenting a folding control for folding a data dimension group in the data table, the data dimension group comprising a base data dimension and at least one other data dimension than the base data dimension; and
in response to receiving an interaction request for the folding control, presenting the base data dimension in the data dimension group, and setting the at least one other data dimension to be invisible.

2. The method of claim 1, wherein the data dimension group is determined based on:
in response to receiving a selection request for a plurality of data dimensions in the data table, presenting a grouping control for setting the data dimension group; and
in response to receiving an interaction request for the grouping control, adding the plurality of data dimensions to the data dimension group.

3. The method of claim 1, further comprising:
presenting an unfolding control for unfolding the data dimension group; and
in response to receiving an interaction request for the unfolding control, setting the at least one other data dimension in the data dimension group to be visible.

4. The method of claim 1, further comprising:
presenting a setting control for setting the data dimension group;
in response to receiving an interaction request for the setting control, presenting a setting page, the setting page comprising a color setting control for setting a color of the data dimension group; and
in response to receiving an interaction request for the color setting control, setting the color of the data dimension group.

5. The method of claim 4, wherein presenting the setting control comprises: presenting the setting control at a location corresponding to the base data dimension.

6. The method of claim 4, wherein the setting page further comprises: a canceling control for ungrouping the data dimension group, and the method further comprises: in response to receiving an interaction request for the canceling control, ungrouping the data dimension group.

7. The method of claim 4, wherein the setting page further comprises: an updating control for updating the data dimension group; and the method further comprises: in response to receiving an interaction request for the updating control, updating the plurality of data dimensions in the data dimension group based on the interaction request.

8. The method of claim 1, further comprising:
in response to determining that an interaction request with the data dimension group satisfies a predetermined condition, presenting a base column setting control for setting the base data dimension; and
in response to receiving an interaction request for the base column setting control, setting a target data dimension in the at least one other data dimension as the base data dimension of the data dimension group.

9. The method of claim 1, further comprising:
storing state information of the data dimension group in configuration data of a user associated with the data table, the state information comprising at least one of the following: an identifier and a color of the data dimension group, a presentation state of the data dimension group, an identifier of the plurality of data dimensions, and an identifier of the base data dimension.

10. The method of claim 9, further comprising:
in response to receiving an interaction request from the user for accessing the data table, reading the state information of the data dimension group from the configuration data of the user; and
presenting the data table based on the state information.

11. The method of claim 1, wherein the data dimension comprises at least one of a data row and a data column.

12. An electronic device comprising:
at least one processing unit; and
at least one memory coupled to the at least one processing unit and storing instructions for execution by the at least one processing unit, the instructions, when executed by the at least one processing unit, causing the electronic device to perform acts comprising:
presenting a folding control for folding a data dimension group in the data table, the data dimension group comprising a base data dimension and at least one other data dimension than the base data dimension; and
in response to receiving an interaction request for the folding control, presenting the base data dimension in the data dimension group, and setting the at least one other data dimension to be invisible.

13. The device of claim 12, wherein the data dimension group is determined based on:
in response to receiving a selection request for a plurality of data dimensions in the data table, presenting a grouping control for setting the data dimension group; and
in response to receiving an interaction request for the grouping control, adding the plurality of data dimensions to the data dimension group.

14. The device of claim 13, wherein the acts further comprise:
presenting an unfolding control for unfolding the data dimension group; and
in response to receiving an interaction request for the unfolding control, setting the at least one other data dimension in the data dimension group to be visible.

15. The device of claim 12, wherein the acts further comprise:
presenting a setting control for setting the data dimension group;
in response to receiving an interaction request for the setting control, presenting a setting page, the setting page comprising a color setting control for setting a color of the data dimension group; and
in response to receiving an interaction request for the color setting control, setting the color of the data dimension group.

16. The device of claim 15, wherein presenting the setting control comprises: presenting the setting control at a location corresponding to the base data dimension.

17. The device of claim 15, wherein the setting page further comprises: a canceling control for ungrouping the data dimension group, and the acts further comprise: in response to receiving an interaction request for the canceling control, ungrouping the data dimension group.

18. The device of claim 15, wherein the setting page further comprises: an updating control for updating the data dimension group; and the acts further comprise: in response to receiving an interaction request for the updating control, updating the plurality of data dimensions in the data dimension group based on the interaction request.

19. The device of claim 1, wherein the acts further comprise:
in response to determining that an interaction request with the data dimension group satisfies a predetermined condition, presenting a base column setting control for setting the base data dimension; and
in response to receiving an interaction request for the base column setting control, setting a target data dimension in the at least one other data dimension as the base data dimension of the data dimension group.

20. A non-transitory computer-readable storage medium storing a computer program thereon which, when executed by a processor, causes the processor to implement acts comprising:
presenting a folding control for folding a data dimension group in the data table, the data dimension group comprising a base data dimension and at least one other data dimension than the base data dimension; and
in response to receiving an interaction request for the folding control, presenting the base data dimension in the data dimension group, and setting the at least one other data dimension to be invisible.
